(19) United States
(12) Patent Application Publication
(10) Pub. No.: US 2008/0285621 A1
(43) Pub. Date: Nov. 20, 2008

(54) Insulated retainer with thermometer for beverage container

(76) Inventor: Christopher G. Rowen, Rockport, MA (US)

Correspondence Address: Paul J. Cook, 115 Pine Street, Manchester, MA, 01944, US

(21) Appl. No.: 11/803,096

(22) Filed: May 14, 2007

(51) Int. Cl. B65D 81/38; G01K 1/14

(52) U.S. Cl. 374/150; 220/739

(57) ABSTRACT

A retainer for a beverage container formed of a flexible, stretchable material and having a temperature sensing means attached to a wall thereof. The retainer is capable of being turned inside out without damage thereto.

### FIELD OF THE INVENTION

This invention relates to an insulated retainer having a thermometer for a beverage container.

### BACKGROUND OF THE INVENTION

Beverages housed in cans or bottles are widely consumed, generally as cold beverages. Exemplary beverages include soft drinks, juice, beer, wine and liquor. Some societies prefer their beverage to be warm. In any event, there is a need for providing the consumer of the beverage with information regarding beverage temperature prior to consuming the beverage.

In addition, consumers prefer that their beverage maintain their desired temperature over the time the beverage in the container is completely consumed.

At the present time, a wide variety of temperature insulation retainers for retaining a beverage container include fixed retainers and flexible retainers. Included in such retainers are collapsible retainers which, when the beverage container is removed therefrom can be compressed and carried in a pocket. This permits the retainer user to utilize it as the consumer travels over time.

U.S. Pat. No. 5,645,196 discloses a retainer for a beverage carton such as for juice or milk. The retainer can include a thermometer that measures the temperature for the beverage in the carton. In order to view the thermometer, the retainer must be transparent. No collapsible beverage containers are disclosed.

U.S. Pat. No. 5,482,373 discloses a temperature indicator for a beverage container. The temperature indicator can be applied directly to the container or can be positioned frictionally into the wall of an insulating retainer that retains the beverage container. The wall of the beverage retainer must be sufficiently inflexible as to retain the thermometer in place by friction forces. No collapsible beverage retainers are disclosed.

Accordingly, it would be desirable to provide a collapsible insulating beverage retainer with a means for measuring temperature, such as a thermometer in a beverage container. Such a retainer would provide the beverage consumer with desired temperature information and ease of portability. In addition, such a retainer would provide ease of securing the temperature sensing means to the retainer by first securing it to an outside surface of the retainer thereby providing easy access to the retainer surface to which it is secured. The retainer then could be turned inside out so that the temperature sensing means would be adjacent to or in contact with the beverage container during use.

### SUMMARY OF THE INVENTION

In accordance with this invention, a retainer formed of a thermal insulating material for a beverage container is provided. The retainer includes a temperature sensing means, such as a thermometer which is positioned on the retainer at a position such that it can measure the temperature on the outside surface of the beverage container. The retainer has a shape such that it can be turned inside out when desired. This permits the temperature sensing means to be initially secured to an easily accessible outside surface of the retainer. The retainer then can be turned inside out so that the secured temperature sensing means is positioned on a newly formed inside surface of the retainer adjacent to or in contact with the beverage container positioned in the retainer. The temperature sensing means is attached peripherally by stitching it directly to the retainer or stitching a web to the retainer which holds the temperature sensing means on the retainer.

### BRIEF DESCRIPTION OF THE DRAWINGS

FIG. 1 is a side view of a retainer of this invention having a temperature sensing means attached thereto.

FIG. 2 is a partial cross sectional view taken along line 2-2 of FIG. 1.

FIG. 3 is a side view of an alternative retainer of this invention.

FIG. 4 is a partial cross sectional view taken along line 4-4 of FIG. 3.

FIG. 5 is a side view of an alternative retainer of this invention.

FIG. 6 is a partial cross sectional view taken along line 6-6 of FIG. 5.

FIG. 7 is a side view of the retainer of this invention having a temperature sensing means attached thereto after being turned inside out.

FIG. 8 is a bottom perspective view of the retainer of this invention.

FIG. 9 is a top perspective view of the retainer of FIG. 8.

FIG. 10 is a cross sectional view of the wall of the retainer of FIG. 9 taken along line 10-10.

### DESCRIPTION OF SPECIFIC EMBODIMENTS

The retainer of this invention having a temperature sensing means attached thereto is configured to retain a beverage container such as a can, bottle or glass. The retainer is formed of a material and is configured so that it can be turned inside out prior to use. The temperature sensing means is secured to a wall of the retainer such as by stitching. The temperature sensing means can be directly attached to the retainer or can be held in place by a retaining wall that is directly attached, such as by stitching to the retainer. The temperature sensing means, such as a conventional liquid crystal temperature indicating material is preferably positioned adjacent to or in contact with the beverage container. When the temperature sensing means initially is attached to or retained in an outside surface of the retainer, it is preferred to turn the retainer inside out to thereby position the temperature sensing means as close as possible to the beverage container so as to provide more accurate temperature measurement. When the temperature sensing means is in position to be viewed by the user, and a retaining web is interposed between the user and the temperature sensing means, the retaining web must be transparent, or at worse, translucent to permit the user to view the temperature sensing means. For ease of producing the retainer of this invention, it is preferred to secure the temperature sensing means to an initial outside surface of the retainer and then turning the retainer inside out. Although more difficult, it is possible to secure the temperature sensing means to an initial inner surface of the retainer.

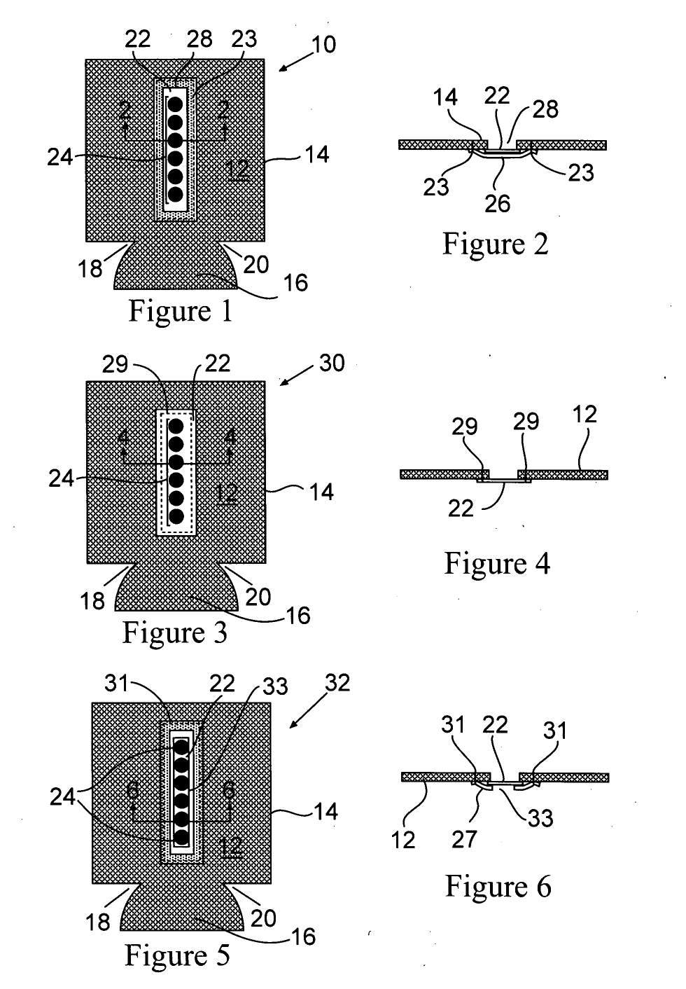

Referring to FIGS. 1 and 2, the retainer 10 comprises a beverage container section 12 comprising a wall 14, a bottom 16 and cutouts 18 and 20. The wall 14 and bottom 16 are formed of single ply or multi ply flexible and/or expandable thermally insulating material. The cutouts 18 and 20 permit the retainer 10 to be compressed relatively flat so that it can be carried in a pocket. The temperature sensing means 22 includes liquid crystal displays (LCD) 24 that light up by being temperature activated and can show any indicia such as a number or a word display indicative of the temperature. The group of LCDs 24 can display a series of temperatures indicative of the degree of coolness or warmth of the beverage container. The temperature sensing means 22 is secured to beverage container section 12 by retaining wall 26 and stitching 23. After the stitching 23 has been completed, the retainer 12 is turned inside out so that the temperature sensing means 22 is closer to the beverage container 35.

As shown in FIG. 2, the temperature sensing means 22 is positioned against the beverage container section 12 by retaining wall 26. When wall 26 is finally positioned on the outside surface of wall 14, it must be transparent or translucent to permit viewing of the LCD 24. When the LCDs 24 are finally positioned against opening 28 on an outside surface of retainer 10, the retaining wall 26 need not be transparent or translucent to permit viewing the LCDs 24 by the user.

Referring to FIGS. 3 and 4, the retainer 30 comprises a beverage container section 12 comprising a wall 14, a bottom 16 and cutouts 18 and 20. The temperature sensing means 22 includes liquid crystal displays (LCD) 24. The temperature sensing means 22 is secured directly to beverage container section 12 by stitching 29. After the stitching 29 has been completed, the retainer 12 is turned inside out so that the temperature sensing means 22 is closer to the beverage container 35.

As shown in FIG. 4, the temperature sensing means 22 is stitched to the beverage container section 12.

Referring to FIGS. 5 and 6, the retainer 32 comprises a beverage container section 12 comprising a wall 14, a bottom 16 and cutouts 18 and 20. The temperature sensing means 22 includes liquid crystal displays (LCD) 24. The temperature sensing means 22 is secured to beverage container section 12 by retaining wall 27 and stitching 31. Due to slots 33, the retainer need not be turned inside out since the temperature sensing means 22 is initially closer to the beverage container.

As shown in FIG. 6, the temperature sensing means 22 is positioned against the beverage container section 12 by retaining wall 27. The slot 33 permits direct air convection between a beverage container within beverage container section 12 and temperature sensing means 22.

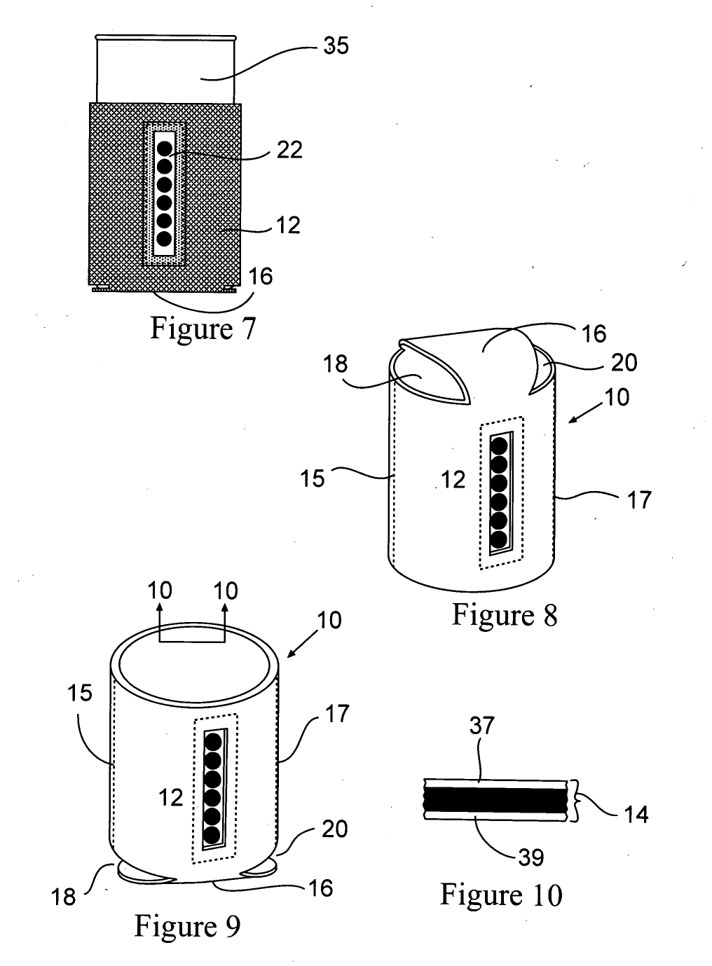

Referring to FIG. 7, in use, a beverage container fits into beverage container section 12 against temperature sensing means 22.

Referring to FIGS. 8 and 9, the beverage container section 12 is formed by stitchings 15 and 17.

Referring to FIG. 10, the wall 14 can comprise a three ply structure wherein the outer plies 37 and 39 are formed of a stretchable, flexible fabric and the inner ply 41 comprises a thermally insulating foam.

1. A thermally insulating retainer for a beverage container formed from a flexible, stretchable material which comprises:
a generally cylindrical body having a generally circular wall and a bottom attached to said wall,
a sufficient portion of said bottom being detached from said wall to permit said retainer being turned inside out while avoiding damage to said retainer,
and a temperature sensing means secured to said wall.

2. The thermally insulating retainer of claim 1 wherein said temperature sensing means is directly sewn on said wall.

3. The thermally insulating retainer of claim 1 wherein said temperature sensing means is retained on said wall by a second retainer sewn on said wall.

4. The thermally insulating retainer of claim 3 wherein said second retainer includes a slot.

5. The thermally insulating retainer of any one of claims 1, 2, 3 or 4 wherein said temperature sensing means includes thermally sensitive liquid crystal displays.
